(19) United States
(12) Patent Application Publication
(10) Pub. No.: US 2024/0375056 A1
(43) Pub. Date: Nov. 14, 2024

(54) MEMBRANE SYSTEM AND METHOD FOR FILTERING SUSPENDED SOLIDS DURING MEMBRANE CLEANING

(71) Applicant: Saltworks Technologies Inc., Richmond (CA)

(72) Inventor: Derek MANDEL, Richmond (CA)

(21) Appl. No.: 18/661,333

(22) Filed: May 10, 2024

Related U.S. Application Data
(60) Provisional application No. 63/466,102, filed on May 12, 2023.

(51) Int. Cl. B01D 65/02; B01D 61/18; B01D 61/22; B01D 69/02

(52) U.S. Cl. CPC B01D 65/02; B01D 61/18; B01D 61/22; B01D 69/02; B01D 2313/18; B01D 2313/243; B01D 2313/60; B01D 2313/70; B01D 2315/10; B01D 2317/04; B01D 2321/02; B01D 2321/04; B01D 2325/02832; B01D 2325/02833; B01D 2325/02834

(57) ABSTRACT

A method for filtering suspended solids from a feed fluid involves filtering the feed fluid by pumping the feed fluid through a first retentate channel of a first cross-flow membrane unit and through a second retentate channel of a second cross-flow membrane unit that is connected in parallel with the first membrane unit. The retentate exiting the units after filtering is pumped through a suspended solids concentrating path. While the filtering is being performed by both membrane units, at least one of the membrane units may be cleaned by performing a forward flush on it in which a portion of the retentate from at least one of the first and the second retentate channels is drawn into a forward flushing path. The forward flushing path is fluidly connected to the retentate channel of the membrane unit that is being forward flushed.

### CROSS-REFERENCE TO RELATED APPLICATION

The present application claims priority to U.S. provisional patent application No. 63/466,102, filed on May 12, 2023, and entitled “Membrane System and Method for Continuously Filtering Suspended Solids”, the entirety of which is hereby incorporated by reference herein.

### TECHNICAL FIELD

The present disclosure is directed at methods, systems, and techniques that permit suspended solids to be filtered from a feed fluid using a porous membrane in a cross-flow membrane unit while concurrently cleaning solids deposits from that membrane.

### BACKGROUND

Ultrafiltration (UF) or microfiltration (MF) is used for filtering suspended solids from a feed fluid to produce a concentrated suspended solids stream and a clarified permeate. Compared to settlement-based solids/liquid separation, UF/MF has a smaller footprint and produces higher quality permeate than a traditional settlement clarifier. UF/MF is, however, energy intensive and prone to membrane fouling because of suspended solids that become lodged in the membranes used for filtering. Various membrane cleaning procedures have been developed to attempt to address UF/MF membrane fouling.

### SUMMARY

According to a first aspect, there is provided a system for filtering suspended solids from a feed fluid, the system comprising: first and second cross-flow membrane units fluidly connected in parallel, wherein the first and second cross-flow membrane units respectively comprise first and second retentate channels for receiving a retentate with at least some of the filtered suspended solids and first and second permeate channels for receiving a permeate from filtering the suspended solids; a suspended solids concentrating path comprising: at least one concentrating path control valve respectively fluidly connected to at least one of the first and second retentate channels; and a first pump fluidly connected to the at least one concentrating path control valve such that the at least one concentrating path control valve fluidly connects the at least one of the first and second retentate channels to the first pump when open and fluidly disconnects the at least one of the first and second retentate channels from the first pump when closed; and a forward flushing path comprising: first and second forward flushing control valves respectively fluidly connected to the first and second retentate channels; a second pump fluidly connected to the first and second forward flushing control valves; and a third forward flushing control valve fluidly connecting the second pump to the suspended solids concentrating path such that when the third forward flushing control valve and at least one of the first or second forward flushing control valves are open, a portion of the retentate is drawn from the at least one of the first and the second retentate channels to the forward flushing path.

The at least one concentrating path control valve may comprise first and second concentrating path control valves respectively fluidly connected to the first and second retentate channels.

The suspended solids concentrating path may further comprise third and fourth concentrating path control valves respectively fluidly connected to the first and second retentate channels such that the suspended solids concentrating path permits recirculation of retentate through the first and second retentate channels.

The first forward flushing control valve may be open and the second forward flushing control valve may be closed, and the second pump may be configured to pump at a flow rate such that a cross-flow velocity through the first retentate channel of the portion of the retentate drawn by the second pump to the forward flushing path is at least twice a cross-flow velocity of the retentate through the second retentate channel.

The system may further comprise a back flushing path, and the back flushing path may comprise: a permeate container fluidly connected to at least one of the first and second permeate channels to receive the permeate therefrom; at least one back flushing control valve respectively fluidly connected to at least one of the first and second permeate channels; and a back flushing pump fluidly connected to the permeate container and to the at least one back flushing control valve such that the at least one back flushing control valve fluidly connects the at least one of the first and second permeate channels to the permeate container when open and fluidly disconnects the at least one of the first and second permeate channels from the permeate container when closed.

The at least one back flushing control valve may comprise first and second back flushing control valves respectively fluidly connected to the first and second permeate channels.

The system may further comprise a sensor positioned to measure a solids deposits metric representative of an amount of solids deposits within at least one of the membrane units.

The solids deposits metric may selected from the group consisting of flux of the permeate produced by the first membrane unit, the flux of the permeate produced by any one of the membrane units, the flux of the permeate collectively produced by all of the membrane units, permeate turbidity prior to the permeate reaching the permeate container, transmembrane pressure across the retentate and permeate channels of any of the membrane units, duration of periods when any of the membrane units is being used to filter the suspended solids, duration of forward flushing performed on any of the membrane units, and duration of back flushing performed on any of the membrane units.

The system may further comprise a controller communicatively coupled to the sensor, to the control valves, and to the pumps, and configured to: receive the solids deposits metric from the sensor; determine that the solids deposits metric for at least one of the membrane units deviates from a baseline by at least a deviation threshold; and in response to the solids deposits metric deviating from the baseline by at least the deviation threshold, commence forward flushing or back flushing of the at least one of the membrane units.

Each of the cross-flow membrane units may comprise a ceramic membrane having a pore size within a range of approximately 0.002 micrometers to about 5.0 micrometers and the retentate channels may have a diameter of at least 2.0 mm.

According to another aspect, there is provided a method for filtering suspended solids from a feed fluid, the method comprising: filtering the feed fluid by pumping the feed fluid through a first retentate channel of a first cross-flow membrane unit and through a second retentate channel of a second cross-flow membrane unit, wherein the first and second cross-flow membrane units are fluidly connected in parallel; pumping retentate output from the retentate channels through a suspended solids concentrating path; and while performing the filtering, performing a first cleaning operation comprising cleaning at least one of the membrane units by performing a forward flush on the at least one of the membrane units, wherein the cleaning comprises drawing at a portion of the retentate from the at least one of the first and the second retentate channels to a forward flushing path that is fluidly connected to the retentate channel of the membrane unit being cleaned.

Both of the membrane units may perform filtering while one or both membrane units are concurrently cleaned.

First and second pumps may respectively pump the retentate through the suspended solids concentrating path and the forward flushing path, and outlets of the first and second pumps may be fluidly coupled together.

The suspended solids concentrating path may recirculate retentate through the first and second retentate channels, respectively.

Only the first membrane unit may be cleaned during the first cleaning operation, and a cross-flow velocity of the portion of the retentate drawn into the forward flushing path may be at least twice a cross-flow velocity of the retentate through the second retentate channel.

The cleaning further may comprise: pausing filtering performed by the at least one of the membrane units undergoing the forward flush; and while the filtering is paused, performing back flushing on the at least one of the membrane units undergoing the forward flush. Performing the back flushing may comprise pumping permeate through the permeate channel of the at least one of the membrane units undergoing the forward flush.

The first cleaning operation may be performed on the first membrane unit, and the method may further comprise performing a second cleaning operation on the second membrane unit. The second cleaning operation may comprise: pausing filtering performed by the second membrane unit; and while the filtering is paused, performing back flushing on the second membrane unit. Performing the back flushing may comprise pumping permeate through the permeate channel of the second membrane unit. In at least some aspects, only the first membrane unit may be cleaned using the forward flushing, and the method may further comprise cleaning the second membrane unit by performing back flushing. Performing the back flushing may comprise pumping permeate through a permeate channel of the second membrane unit.

The method may further comprise, prior to performing the first cleaning operation: measuring a solids deposits metric representative of an amount of solids deposits within at least one of the membrane units; determining that the solids deposits metric for the at least one of the membrane units deviates from a baseline by at least a deviation threshold; and in response to the solids deposits metric deviating from the baseline by at least the deviation threshold, commencing the first cleaning operation.

The solids deposits metric may be selected from the group consisting of flux of the permeate produced by the first membrane unit, the flux of the permeate produced by any one of the membrane units, the flux of the permeate collectively produced by all of the membrane units, permeate turbidity prior to the permeate reaching the permeate container, transmembrane pressure across the retentate and permeate channels of any of the membrane units, duration of periods when any of the membrane units is being used to filter the suspended solids, duration of forward flushing performed on any of the membrane units, and duration of back flushing performed on any of the membrane units.

Each of the cross-flow membrane units may comprise a ceramic membrane having a pore size within a range of approximately 0.002 micrometers to about 5.0 micrometers and the retentate channels may have a diameter of at least 2.0 mm.

This summary does not necessarily describe the entire scope of all aspects. Other aspects, features and advantages will be apparent to those of ordinary skill in the art upon review of the following description of specific embodiments

### BRIEF DESCRIPTION OF THE DRAWINGS

In the accompanying drawings, which illustrate one or more example embodiments:

FIG. 1 is a schematic of a system comprising membrane units fluidly connected with various conduits, valves, and pumps to permit either of the membrane units to concurrently filter suspended solids while being cleaned.

For purposes of clarity, not every component is labeled, nor is every component of each embodiment shown where illustration is not necessary to allow those of ordinary skill in the art to understand what is depicted.

### DETAILED DESCRIPTION

UF and MF units generally comprise a porous membrane separating permeate and retentate channels that are respectively fluidly coupled to opposing sides of the porous membrane. In typical operation, a feed fluid having suspended solids therein is pumped through the retentate channel. Under pressure, at least some of liquid in the feed fluid is forced through the membrane. Undissolved solids present in the feed fluid are referred to as “suspended solids”. As the feed fluid is forced through the membrane, at least some of those suspended solids are filtered by the membrane. Some of the filtered suspended solids become trapped onto the membrane's surface and in the membrane's pores. The portion of the feed fluid that does not pass through the membrane is referred to as “retentate”, while the liquid that does pass through the membrane is referred to as “permeate”. The solids trapped on and in the membrane can cause membrane fouling.

In order to dislodge those trapped solids, the membranes may be cleaned from time-to-time (e.g., intermittently or periodically). For example, “forward flushing” may be used, in which a cleaning solution (e.g., a fresh feed fluid) is pumped through the UF/MF unit's retentate channel. In order to increase cross-flow velocity during forward flushing, filtration of feed fluid is paused during forward flushing (i.e., the UF/MF unit does not produce a filtrate while being forward flushed). Alternatively, “back flushing” may be used, in which a cleaning solution (e.g., a permeate) is pumped into the UF/MF unit's permeate channel, thereby forcing that cleaning solution across the membrane in the opposite direction as the feed fluid during normal operation (i.e., operation when the UF/MF unit is being used to filter suspended solids from the feed fluid). An UF/MF unit that is being cleaned is not concurrently used to filter suspended solids from the feed fluid. Consequently, in a system in which either the UF/MF unit(s) are either being used for filtering or being cleaned, performing cleaning corresponds to system downtime and a lost opportunity to perform filtering.

The various embodiments described herein provide systems and methods in which a system comprising at least two membrane-based filtration units can be used to filter suspended solids from a feed fluid while also cleaning at least one of the filtration units. For example, in a system comprising two membrane-based filtration units, one or both of the filtration units may be used to filter suspended solids from the feed fluid, while either of the membrane units is also being cleaned. In this way, the system can be used to continuously filter suspended solids from the feed fluid while also cleaning one of the filtration units. More particularly, the system may comprise UF and/or MF units and various conduits, pumps, and valves as described further below to permit either of the units to be intermittently or periodically cleaned; this cleaning is referred to as “flushing”. The operational reliability and efficiency of the UF/MF units are improved through simultaneously filtering suspended solids and cleaning suspended solids deposits from the UF/MF units' membranes.

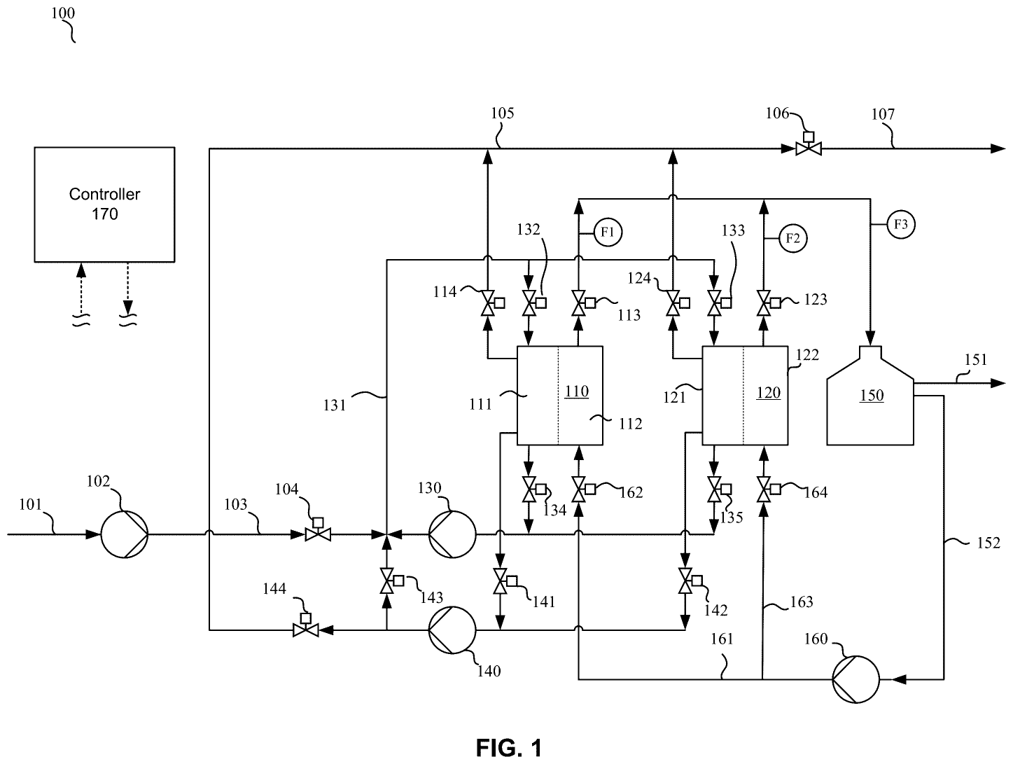

FIG. 1 shows a schematic of an example system 100 configured to permit concurrent membrane-based filtration of suspended solids and membrane cleaning. Forward or back flushes, as described further below, are performed from time-to-time for membrane cleaning. The system 100 comprises:
1) first and second cross-flow membrane units 110, 120 fluidly connected in parallel, respectively comprising first and second retentate channels 111, 121 for receiving the filtered suspended solids and first and second permeate channels 112, 122 for receiving a permeate from the filtering;
2) a suspended solids concentrating path comprising:
   i) a first set of concentrating path control valves 132, 134 respectively controlling fluid entering and leaving the first membrane unit's 110 retentate channel 111, the valves 132, 134 fluidly connecting the first retentate channel 111 to the suspended solids concentrating path when open;
   ii) a second set of concentrating path control valves 133, 135 respectively controlling fluid entering and leaving the second membrane unit's 120 retentate channel 121, the valves 133, 135 fluidly connecting the second retentate channel 111 to the suspended solids concentrating path when open; and
   iii) a first pump 130 (which may, for example, be a circulation pump) fluidly connected between the first set of control valves 132, 134 and fluidly connected between the second set of control valves 133, 135 to permit fluid to be routed from the outlets to the inlets of the retentate channels 111, 121, the first pump 130 for circulating suspended solids along the suspended solids concentrating path and through one or both of the first retentate channel 111 (when the first set of valves 132, 134 is open) and the second retentate channel 121 (when the second set of valves 133, 135 is open); and
3) a forward flushing path comprising:
   i) a second pump 140, which may, for example, be a circulation pump;
   ii) first and second forward flushing control valves 141, 142 respectively fluidly coupled between outlets of the first and second membrane units' 110, 120 retentate channels 111, 121 and an inlet of the second pump 140; and
   iii) a third forward flushing control valve 143 fluidly coupling outlets of the first and second pumps 130, 140 together, thereby enabling the forward flushing path and the suspended solids concentrating path to be fluidly coupled together (when the third forward flushing valve 143 is open) or fluidly disconnected from each other (when the third forward flushing valve 143 is closed).

Each of the suspended solids concentrating path and the forward flushing path is fluidly connected to the membrane units' 110, 120 retentate channels 111, 121, and the two paths may be connected via control valve 143. By virtue of the second pump 140 being fluidly connected to the first pump 130 and to the suspended solids concentrating path through the third forward flushing control valve 143 as described above, when the third forwarding flushing control valve 143 and at least one of the first and second forward flushing control valves 141, 142 are open, turning the second pump 140 on draws retentate from at least one of the first and second retentate channels 111, 121. In other words, in this configuration a portion of fluid previously flowing through the suspended solids concentrating path is diverted to the forward flushing path, and the second pump 140 is operated such its drawing power results in the diverted fluid flows at a higher velocity through the forward flushing path than the fluid remaining in the suspended solids concentrating path. The second pump 140 acts as a booster pump that effectively boosts the velocity of the diverted fluid flowing through the forward flushing path. Performing forward flushing in this manner uses fluid diverted from the suspended solids concentrating path instead of a fresh cleaning solution for cleaning, while permitting both membrane units 110, 120 to also produce filtrate, thereby increasing efficiency. Intermittently activating, as opposed to continuously running, the second pump 140 for forward flushing is prudent to mitigate energy usage and membrane wear; it also may introduce spikes in fluid velocity/pressure when the pump 140 is activated, which helps to dislodge solids deposits off membranes, as mentioned below.

As shown in FIG. 1 and as discussed in further detail below, the feed fluid may be pumped into the membrane units' 110, 120 retentate channels 111, 121 via control valves 132, 133, respectively. In at least some embodiments, the system 100 may then be configured to filter suspended solids from the feed fluid and concurrently clean at least one of the membrane units 110, 120 using forward flushing when at least one of the membrane units 110, 120 is fluidly connected to the second pump 140 via the first forward flushing control valve 141 (in respect of the first membrane unit 110) and the second forward flushing control valve 142 (in respect of the second membrane unit 120). Presume, for example, that the first membrane unit 110 is fluidly connected to the second pump 140 by virtue of the first forward flushing control valve 141 fluidly connecting the first retentate channel 111 to the second pump 140; and that the second membrane unit 120 is fluidly disconnected from the second pump 140 by virtue of the second forward flushing control valve 142 being closed. In this example, the second pump 140 may draw fluid through the forward flushing path and impart a sudden increase in cross-flow velocity to the fluid as it flows through the first retentate channel 111, which in at least some embodiments is at least two times higher, than the cross-flow velocity of the fluid flowing through the second retentate channel 121 and the suspended solids concentrating path. The higher cross-flow velocity is useful for cleaning, while the sudden increase in cross-flow velocity of the fluid in the first retentate channel 111 disturbs and dislodges the suspended solids that may have become trapped onto the first membrane unit's 110 membrane surfaces and pores. Analogously, the second retentate channel 121 may be fluidly connected to, and the first retentate channel 111 may be fluidly disconnected from, the second pump 140. Both membrane units 110, 120, regardless of which is connected to the forward flushing path and which is connected to the suspended solids concentrating path, may in at least some embodiments be used to filter suspended solids from the feed fluid. Either of the membrane units 110, 120 when being forward flushed is cleaned without having to pause suspended solids filtering, and without having to introduce fresh cleaning solution.

The system 100 may in at least some embodiments, including in the embodiment depicted in FIG. 1, further comprise a back flushing path. In FIG. 1, the back flushing path comprises:
1) a back flushing pump 160, which may, for example, be a pressure pump;
2) a permeate container 150 fluidly connected to at least one of the first and second permeate channels 112, 122 for receiving permeates output by at least one of the first and second membrane units 110, 120, respectively; and to an inlet of the back flushing pump 160; and
3) first and second back flushing control valves 162, 164 fluidly connected to the first and second permeate channels 112, 122, respectively, and to an outlet of the back flushing pump 160, thereby enabling a fluidic connection or a fluidic disconnection of the back flushing path to the membrane units 110,120.

When the first back flushing control valve 162 is open and the back flushing pump 160 is on, the back flushing pump 160 delivers permeate from the permeate container 150 through the first permeate channel 112's outlet, thereby flushing some permeate from the first permeate channel 112 to the first retentate channel 111. Similarly, when the second back flushing control valve 164 is open and the back flushing pump 160 is on, the back flushing pump 160 delivers permeate from the permeate container 150 through the second permeate channel 122's outlet, thereby flushing some permeate from the second permeate channel 122 to the second retentate channel 121.

As described in further detail below, one of the membrane units 110, 120 may be configured to filter suspended solids from the feed fluid when it is connected to the forward flushing path or the suspended solids concentrating path, while the other of the membrane units 110, 120 may have its membrane cleaned through back flushing. Filtering is paused for a membrane unit 110, 120 that is undergoing back flushing; for example, valve 132 may be closed when the first membrane unit 110 is being back flushed, and valve 133 may be closed when the second membrane unit 120 is being back flushed.

In at least some embodiments, back flushing may be performed with the first and second forward flushing control valves 141, 142 open and the second pump 140 on. This applies suction through the retentate channels 111, 121 to the membrane units' 110, 120 membranes, which increases the velocity of the permeate being back flushed through those membranes. This effectively concurrently performs back flushing and forwarding flushing on the same membrane unit 110, 120.

In at least some embodiments, the system 100 further comprises at least one sensor to measure a solids deposits metric representative of an amount of solids deposits within at least one of the membrane units 110, 120. Example sensors comprise, for example, any one or more of first through third flow meters F1, F2, F3 respectively measuring a flux of permeate produced by the first membrane unit 110, the second membrane unit 120, and collectively by the first and second membrane units 110, 120 en route to the permeate container 150; a turbidity meter (not shown in FIG. 1) to measure the turbidity of the permeate produced from the membrane units 110, 120 prior to reaching the permeate container 150; a pressure gauge (not shown in FIG. 1) to measure the transmembrane pressure change across the permeate and retentate channels 111, 112, 121, 122 of the membrane units 110, 120 while filtering suspended solids; and a timer (not shown in FIG. 1) to measure periods when the system 100 is filtering suspended solids from the feed fluid, cleaning filtered solids from the units' 110, 120 membranes using forward flushing, or cleaning filtered solids from the units' 110, 120 membranes using back flushing. The solids deposits metric may be evaluated through comparing any one or more of the permeate flux deviation, the permeate turbidity deviation, or the filtration pressure profile to a baseline established during operation of the membrane units 110, 120 under otherwise (aside from solids deposits) identical operating conditions. For example, a baseline may be determined from a flux reading obtained using the first flow meter F1 when operating the first membrane unit 110 immediately after it has undergone a cleaning cycle that has completely flushed away any solids deposits from its membrane. When the flux of the permeate output by the first membrane unit 110 is subsequently measured and deviates by more than a deviation threshold, such as 10%, of the baseline, a forward flushing may be performed on the first membrane unit 110. If after the forward flushing the first membrane unit's 110 membrane has not been adequately cleaned (e.g., the measured flux may still not have returned to baseline), a back flushing may be performed. A similar methodology can be applied in respect of the second membrane unit 120, the second flow meter F2, and measurements of the flux of the permeate output by the second membrane unit 120.

In at least some embodiments, the system 100 further comprises a controller 170 communicatively coupled to the various valves, pumps, and sensors comprising part of the suspended solids concentrating path, the forward flushing path, and the back flushing path. The controller 170 is configured to receive the solids deposits metric information collected through the sensor(s); determine that the solids deposits metric deviates from the baseline; and based on the solids deposits metric, set the operation mode of the system 100 to, for example, forward flushing or back flushing. The controller 170 may ensure one of the membrane units 110, 120 is used to filter suspended solids while the other of the membrane units 110, 120 may be cleaned via forward flushing or back flushing. The controller 170 may be implemented using one or more suitable processing units. A suitable controller 170 may comprise, for example, one or more of an integrated circuit (IC), a monolithic integrated circuit (MIC), an application specific integrated circuit (ASIC), a field programmable gate array (FPGA), a programmable logic controller (PLC), a system-on-a-chip (SoC), an artificial intelligence (AI) accelerator, or a processor and a non-transitory computer readable medium communicatively coupled to the processor and having stored thereon computer program code that is executable by the processor to perform the methods as described herein. Examples of computer readable media that are non-transitory include disc-based media such as CD-ROMs and DVDs, magnetic media such as hard drives and other forms of magnetic disk storage, semiconductor-based media such as flash media, random access memory (including DRAM and SRAM), and read only memory.

In at least some embodiments, the cross-flow membrane units 110, 120 comprise one or more ceramic membranes connected in series or in parallel, and the ceramic membrane has a pore size in a range from about 0.002 micrometers to about 5.0 micrometers. The retentate channels 111, 121 each have a diameter of at least 2.0 mm enabling the filtering of the suspended solids from the feed fluid and the passing of the filtered suspended solids through the retentate channels 111, 121 at a cross-flow velocity of at least about 1.0 meters/second when the membrane units 110, 120 are connected to the suspended solids concentrating path. The system 100 may be operated so that the cross-flow velocity in the retentate channels 111, 121 is at least 2.0 meters/second when one or both of the membrane units 110, 120 are connected to the forward flushing path. The ceramic membrane in the membrane units 110, 120 can withstand during forward or back flushing operations a sudden pressure change from 0 psi to 150 psi to cause a sudden hydraulic disturbance to suspended solids settled on membrane surfaces and within membrane pores. The hydraulic disturbance can dislodge suspended particles, thereby cleaning membranes.

In example operation, the system 100 may be used to filter suspended solids from the feed fluid using one of the membrane units 110, 120 while concurrently cleaning suspended solids from the membrane of the other of the membrane units 110, 120. For example, one of the membrane units 110, 120 may be fluidly coupled to the suspended solids concentrating path to filter suspended solids from the feed fluid, while the other of the membrane units 110, 120 may be fluidly coupled to either the forward or back flushing paths to clean filtered solids from that unit's 110, 120 membrane. In this way, the system 100 may concurrently be used to filter suspended solids from the feed fluid while also cleaning at least one of the membrane units 110, 120. Forward or back flushing may be done intermittently to one or both of the membrane units 110, 120. Examples operation modes are described in further detail below.

In operation, the feed fluid to be treated by the system 100 is introduced via conduit 101. A feed pump 102 pressurizes the feed fluid and pumps the pressurized feed fluid via conduit 103 and control valve 104 into the suspended solids concentrating path. The first pump 130 pumps via conduit 131 and control valves 132, 133 the pressurized feed fluid through at least one of the membrane units 110, 120. At least one of the membrane units 110, 120 filters suspended solids from the pressurized feed fluid to concentrate suspended solids within at least one of the retentate chambers 111, 121 and to produce a permeate within at least one of the permeate chambers 112, 122. The retentate with concentrated suspended solids exits the membrane units 110, 120 and is circulated via control valves 134,135 by the first pump 130 through at least one of the membrane units 110, 120 to further concentrate suspended solids. The feed pump 102 may continuously pump a certain amount of fresh feed fluid into the suspended solids concentrating path for filtering and concentrating suspended solids. A portion of the fluid with concentrated suspended solids may be discharged via control valves 114, 124, 106, and conduits 105, 107 out of the suspended solids concentrating path and the system 100. The produced permeate is directed to the permeate container 150 and some of the permeate is discharged via conduit 151 out of the system 100.

By controlling the various pumps 102, 130, 140, 160 and valves 104, 106, 113, 114, 123, 124, 132, 133, 134, 135, 141, 142, 143, 144, 162, 164, the controller 170 controls the various operation modes of the system 100. Table 1 below summarizes these operation modes and their corresponding valve and pump states.

TABLE 1
System Operation Modes and Corresponding Valve and Pump States

| | Open | Closed | |
|---|---|---|---|
| Operation Mode | Valves | Valves | Pump Status |
| Both membranes units 110, 120 are connected to | 104, 106, | 141, 142, | Pumps 102, |
| the suspended solids concentrating path to filter | 113, 114, | 143, 144, | 130 are on; |
| suspended solids. | 123, 124, | 162, 164. | pumps 140, |
| | 132, 133, | | 160 are off. |
| | 134, 135. | | |
| First membrane unit 110 connected to the | 104, 106, | 135, 141, | Pumps 102, |
| suspended solids concentrating path to filter | 113, 114, | 144, 162, | 130, 140 are |
| suspended solids and second membrane unit 120 | 123, 124, | 164. | on; pump 160 |
| connected to the forward flushing path, thereby | 132, 133, | | is off. |
| simultaneously treating the feed fluid using first | 134, 142, | | |
| membrane unit 110 and cleaning solids deposits | 143. | | |
| from second membrane unit 120 using forward | | | |
| flushing. | | | |
| Second membrane unit 120 connected to the | 104, 106, | 134, 142, | Pumps 102, |
| suspended solids concentrating path to filter | 113, 114, | 144, 162, | 130, 140 are |
| suspended solids and first membrane unit 110 | 123, 124, | 164. | on; pump 160 |
| connected to the forward flushing path, thereby | 132, 133, | | is off. |
| simultaneously treating the feed fluid using second | 135, 141, | | |
| membrane unit 120 and cleaning solids deposits | 143. | | |
| from first membrane unit 110 using forward | | | |
| flushing. | | | |
| First membrane unit 110 connected to the | 104, 106, | 114, 123, | Pumps 102, |
| suspended solids concentrating path to filter | 113, 124, | 133, 135, | 130, 160 are |
| suspended solids and second membrane unit 120 | 132, 134, | 141, 142, | on; pump 140 |
| connected to the back flushing path, thereby | 164. | 143, 144, | is off. |
| simultaneously treating the feed fluid using first | | 162. | |
| membrane unit 110 and cleaning solids deposits | | | |
| from second membrane unit 120 using back | | | |
| flushing. | | | |
| Second membrane unit 120 connected to the | 104, 106, | 113, 124, | Pumps 102, |
| suspended solids concentrating path to filter | 114, 123, | 132, 134, | 130, 160 are |
| suspended solids and first membrane unit 110 | 133, 135, | 141, 142, | on; pump 140 |
| connected to the back flushing, thereby | 162. | 143, 144, | is off. |
| simultaneously treating the feed fluid using first | | 164. | |
| membrane unit 110 and cleaning solids deposits | | | |
| from second membrane unit 120 using back | | | |
| flushing. | | | |
| First membrane unit 110 connected to the | 104, 106, | 114, 123, | Pumps 102, |
| suspended solids concentrating path to filter | 113, 132, | 124, 133, | 130, 140, 160 |
| suspended solids and second membrane unit 120 | 134, 142, | 135, 141, | are on. |
| connected to the back flushing path, thereby | 144, 164. | 143, 162. | |
| simultaneously treating the feed fluid using first | | | |
| membrane unit 110 and cleaning solids deposits | | | |
| from second membrane unit 120 using enhanced | | | |
| back flushing. | | | |
| Second membrane unit 120 connected to the | 104, 106, | 113, 114, | Pumps 102, |
| suspended solids concentrating path to filter | 123, 133, | 124, 132, | 130, 140, 160 |
| suspended solids and first membrane unit 110 | 135, 141, | 134, 142, | are on. |
| connected to the back flushing path, thereby | 144, 162. | 143, 164. | |
| simultaneously treating the feed fluid using first | | | |
| membrane unit 110 and cleaning solids deposits | | | |
| from second membrane unit 120 using enhanced | | | |
| back flushing. | | | |

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, two components are “fluidly connected” or in “fluidic connection” if they are directly or indirectly physically connected (e.g., via a conduit) such that a fluid can be transferred from one of those components to the other via that direct or indirect physical connection.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. A system for filtering suspended solids from a feed fluid, the system comprising:
(a) first and second cross-flow membrane units fluidly connected in parallel, wherein the first and second cross-flow membrane units respectively comprise first and second retentate channels for receiving a retentate with at least some of the filtered suspended solids and first and second permeate channels for receiving a permeate from filtering the suspended solids;
(b) a suspended solids concentrating path comprising:
(i) at least one concentrating path control valve respectively fluidly connected to at least one of the first and second retentate channels; and
(ii) a first pump fluidly connected to the at least one concentrating path control valve such that the at least one concentrating path control valve fluidly connects the at least one of the first and second retentate channels to the first pump when open and fluidly disconnects the at least one of the first and second retentate channels from the first pump when closed; and
(c) a forward flushing path comprising:
(i) first and second forward flushing control valves respectively fluidly connected to the first and second retentate channels;
(ii) a second pump fluidly connected to the first and second forward flushing control valves; and
(iii) a third forward flushing control valve fluidly connecting the second pump to the suspended solids concentrating path such that when the third forward flushing control valve and at least one of the first or second forward flushing control valves are open, a portion of the retentate is drawn from the at least one of the first and second retentate channels to the forward flushing path.

2. The system of claim 1, wherein the at least one concentrating path control valve comprises first and second concentrating path control valves respectively fluidly connected to the first and second retentate channels.

3. The system of claim 2, wherein the suspended solids concentrating path further comprises third and fourth concentrating path control valves respectively fluidly connected to the first and second retentate channels such that the suspended solids concentrating path permits recirculation of retentate through the first and second retentate channels.

4. The system of claim 1, wherein the first forward flushing control valve is open and the second forward flushing control valve is closed, and wherein the second pump is configured to pump at a flow rate such that a cross-flow velocity through the first retentate channel of the portion of the retentate drawn by the second pump to the forward flushing path is at least twice a cross-flow velocity of the retentate through the second retentate channel.

5. The system of claim 1, further comprising a back flushing path, the back flushing path comprising:
(a) a permeate container fluidly connected to at least one of the first and second permeate channels to receive the permeate therefrom;
(b) at least one back flushing control valve respectively fluidly connected to at least one of the first and second permeate channels; and
(c) a back flushing pump fluidly connected to the permeate container and to the at least one back flushing control valve such that the at least one back flushing control valve fluidly connects the at least one of the first and second permeate channels to the permeate container when open and fluidly disconnects the at least one of the first and second permeate channels from the permeate container when closed.

6. The system of claim 5, wherein the at least one back flushing control valve comprises first and second back flushing control valves respectively fluidly connected to the first and second permeate channels.

7. The system of claim 5, further comprising a sensor positioned to measure a solids deposits metric representative of an amount of solids deposits within at least one of the membrane units.

8. The system of claim 7, wherein the solids deposits metric is selected from the group consisting of flux of the permeate produced by the first membrane unit, the flux of the permeate produced by any one of the membrane units, the flux of the permeate collectively produced by all of the membrane units, permeate turbidity prior to the permeate reaching the permeate container, transmembrane pressure across the retentate and permeate channels of any of the membrane units, duration of periods when any of the membrane units is being used to filter the suspended solids, duration of forward flushing performed on any of the membrane units, and duration of back flushing performed on any of the membrane units.

9. The system of claim 7, further comprising a controller communicatively coupled to the sensor, to the control valves, and to the pumps, and configured to:
(a) receive the solids deposits metric from the sensor;
(b) determine that the solids deposits metric for at least one of the membrane units deviates from a baseline by at least a deviation threshold; and
(c) in response to the solids deposits metric deviating from the baseline by at least the deviation threshold, commence forward flushing or back flushing of the at least one of the membrane units.

10. The system of claim 1, wherein each of the cross-flow membrane units comprises a ceramic membrane having a pore size within a range of approximately 0.002 micrometers to about 5.0 micrometers and wherein the retentate channels have a diameter of at least 2.0 mm.

11. A method for filtering suspended solids from a feed fluid, the method comprising:
(a) filtering the feed fluid by pumping the feed fluid through a first retentate channel of a first cross-flow membrane unit and through a second retentate channel of a second cross-flow membrane unit, wherein the first and second cross-flow membrane units are fluidly connected in parallel;
(b) pumping retentate output from the retentate channels through a suspended solids concentrating path; and
(c) while performing the filtering, performing a first cleaning operation comprising cleaning at least one of the membrane units by performing a forward flush on the at least one of the membrane units, wherein the cleaning comprises drawing at a portion of the retentate from the at least one of the first and second retentate channels to a forward flushing path that is fluidly connected to the retentate channel of the membrane unit being cleaned.

12. The method of claim 11, wherein both of the membrane units are performing filtering while one or both membrane units are concurrently cleaned.

13. The method of claim 11, wherein first and second pumps respectively pump the retentate through the suspended solids concentrating path and the forward flushing path, and wherein outlets of the first and second pumps are fluidly coupled together.

14. The method of claim 11, wherein the suspended solids concentrating path recirculates retentate through the first and second retentate channels, respectively.

15. The method of claim 11, wherein only the first membrane unit is being cleaned during the first cleaning operation, and wherein a cross-flow velocity of the portion of the retentate drawn into the forward flushing path is at least twice a cross-flow velocity of the retentate through the second retentate channel.

16. The method of claim 11, wherein the cleaning further comprises:
(a) pausing filtering performed by the at least one of the membrane units undergoing the forward flush; and
(b) while the filtering is paused, performing back flushing on the at least one of the membrane units undergoing the forward flush, wherein performing the back flushing comprises pumping permeate through the permeate channel of the at least one of the membrane units undergoing the forward flush.

17. The method of claim 11, wherein the first cleaning operation is performed on the first membrane unit, and further comprising performing a second cleaning operation on the second membrane unit, wherein the second cleaning operation comprises:
(a) pausing filtering performed by the second membrane unit; and
(b) while the filtering is paused, performing back flushing on the second membrane unit, wherein performing the back flushing comprises pumping permeate through the permeate channel of the second membrane unit.
(c) wherein only the first membrane unit is being cleaned using the forward flushing, and further comprising cleaning the second membrane unit by performing back flushing, wherein performing the back flushing comprises pumping permeate through a permeate channel of the second membrane unit.

18. The method of claim 11, further comprising, prior to performing the first cleaning operation:
(a) measuring a solids deposits metric representative of an amount of solids deposits within at least one of the membrane units;
(b) determining that the solids deposits metric for the at least one of the membrane units deviates from a baseline by at least a deviation threshold; and
(c) in response to the solids deposits metric deviating from the baseline by at least the deviation threshold, commencing the first cleaning operation.

19. The method of claim 11, wherein the solids deposits metric is selected from the group consisting of flux of the permeate produced by the first membrane unit, the flux of the permeate produced by any one of the membrane units, the flux of the permeate collectively produced by all of the membrane units, permeate turbidity prior to the permeate reaching the permeate container, transmembrane pressure across the retentate and permeate channels of any of the membrane units, duration of periods when any of the membrane units is being used to filter the suspended solids, duration of forward flushing performed on any of the membrane units, and duration of back flushing performed on any of the membrane units.

20. The method of claim 11, wherein each of the cross-flow membrane units comprises a ceramic membrane having a pore size within a range of approximately 0.002 micrometers to about 5.0 micrometers and wherein the retentate channels have a diameter of at least 2.0 mm.
